(19) United States
(12) Patent Application Publication
(10) Pub. No.: US 2004/0060749 A1
(43) Pub. Date: Apr. 1, 2004

(54) Self-generating electric motor for electric vehicles

(76) Inventor: Edward H. Roman, Victorville, CA (US)

Correspondence Address: Edward H. Roman, Apt. #108, 16950 Jasmine St., Victorville, CA, 92392, US

(21) Appl. No.: 10/260,646

(22) Filed: Sep. 27, 2002

(51) Int. Cl. B61C 9/38; B60L 11/02

(52) U.S. Cl. 180/65.1; 290/27

(57) ABSTRACT

A self-generating electric motor to create a major breakthrough in electrical charging technology substantially increases mileage range, reduce air pollution and improve performance. These improvements would make such an electric vehicle more attractive to the general public as a viable transportation option. The inventive device includes 2 electric motors, one generator, battery and starter unit, common drive shaft and universal joints.

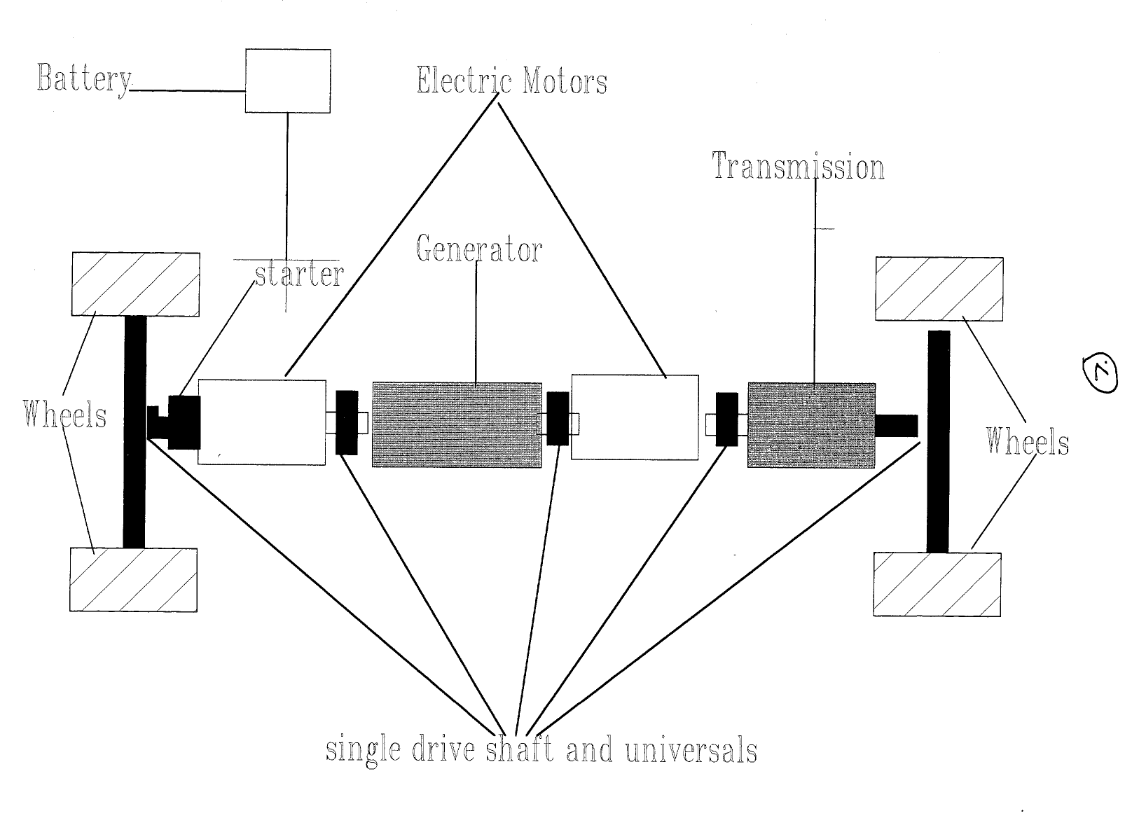

### FIELD OF THE INVENTION

The present invention relates generally to electric motors and more specifically it relates to a self-generating electric motor to create a major breakthrough in battery technology needed to enhance the operation of electric vehicles.

### DESCRIPTION OF THE PRIOR ART

It can be appreciated that electric motors have been in use for years in vehicles.

The main problem with conventional electric vehicles is inadequate battery power. These vehicles use a series of lead-acid or nickel-cadmium batteries having a limited range of 100 miles on a single charge. A major breakthrough in battery technology is needed before an electric vehicle can be feasibly considered as a viable transportation option to the internal combustion engine.

Another problem with the present electric vehicles is that they are set up as a hybrid system. Using an electric motor coupled to a gasoline engine as a propulsion unit. The battery system has to be serviced and recharged quite frequently. Also, the gasoline engine has to be serviced periodically and stop for gas at frequent intervals.

At the present time, the electric vehicle uses a battery system that is composed of a series of batteries with a total weight of approximately 1,000 lbs.

### SUMMARY OF THE INVENTION

In view of the foregoing disadvantages inherent in the known types of electric motors now present in the prior art, the present invention provides a new self-generating electric motor construction wherein the same can be utilized to create a major breakthrough in battery technology.

The general purpose of the present invention, which will be described subsequently in greater detail, is to provide a new self-generating electric motor that has many of the advantages of the electric motor mentioned heretofore and many novel features. The result is a new self-generating electric motor which is not anticipated, rendered obvious, suggested, or even implied by any of the prior art electric motor, either alone or in any combination thereof.

To attain this, the present invention generally is comprised of 2 electric motors, one generator, one battery and starter unit, a common drive shaft and universal joints.

The first and second electric motors will be of a size and weight to handle 200 horsepower. The generator will be of a size and weight to generate the electrical energy required. The universal joints situated between each of the components will facilitate separate removal of each component for repairs.

There has thus been outlined, rather broadly, the more important features of the invention in order that the detailed description thereof may be better understood, and in order that the present contribution to the art may be better appreciated. There are additional features of the invention that will be described hereinafter.

It is to be understood that the invention is not limited in its application to the details of construction and to the arrangements of the components set forth in the following description and illustrated in the attached drawing. The invention is capable of being practiced and carried out in various ways. Also, it is to be understood that the phraseology and terminology employed herein are for the purpose of the description and should not be regarded as limiting.

The primary objective of the present invention is to provide a self-generating electric motor that will overcome the shortcomings of the prior art devices.

The second objective is to provide a self-generating electric motor to create a major breakthrough in battery technology needed.

The third objective is to provide a self-generating electric motor that will enhance the mileage range considerably.

The fourth objective is to provide a self-generating electric motor that may do away with the need to recharge the battery system.

The fifth objective is to provide a self-generating electric motor that will eliminate the use of a battery system comprised of a series of batteries with a combined weight of 1,000 lbs.

The sixth objective is to provide a self-generating electric motor that eliminates the use of a hybrid system; a gasoline engine coupled with an electric motor.

The seventh objective is to provide a self-generating electric motor that will produce electrical energy from mechanical energy.

The eight objectives are to provide a self-generating electric motor that will produce mechanical energy from electrical energy.

The ninth object is to provide a self-generating electric motor that will eliminate air pollution caused by gasoline engines.

Other objectives and advantages of the present invention will become obvious to the reader and it is intended that these objects and advantages be within the scope of the present invention.

To the accomplishment of the above and related objectives, this invention may be embodied in the form illustrated in the accompanying sketch, attention being called to the fact, however, that the sketch is illustrative only, and that changes may be made in the specific construction illustrated.

### BRIEF DESCRIPTION OF THE DRAWING

Various other objects, features and attendant advantages of the present invention will become fully appreciated as the same becomes better understood when considered in conjunction with the accompanying sketch, in which like reference characters designate the same or similar parts throughout the view, and wherein:

The sketch is an exploded view of the present invention showing all of the components.

### DESCRIPTION OF THE PREFERRED EMBODIMENT

Turning now descriptively to the sketch, in which similar reference characters denote similar elements throughout the view, the attached sketch illustrates a self-generating electric motor. This is comprised of two electric motors rated at 200 horsepower each, One generator, One battery and starter unit, one common driveshaft and universal joints.

The electric motors and generator would be of the “off the shelf” variety and to be redesigned to fit the common drive shaft. The structural consideration of the electric motors and the generator will need to be determined based on the size of the vehicle being used.

The critical part of this concept is in the engineering modification to be made to the common driveshaft and universal joints so they can be designed to be an integral part of the two motors, generator and transmission.

The invention will have multiple levels of usage, such as in vehicles of all sizes such as trucks, busses, tractors, earth-movers, etc.

The battery and starter would supply power to the first electric motor and physically positioned in front of the common shaft. When voltage is applied to the magnetic field windings of the motor, the interaction created between the magnetic flux established by the field windings will produce torque, causing the motor drive shaft to rotate, the speed of rotation being directionally proportional to the amount of power applied to the motor.

The drive shaft of this motor is mechanically linked via a universal joint to the generator, which would be driven at the speed of the electric motor. The windings on the armature of the generator would magnetically induce a voltage into the stator windings of the generator and an output voltage would be applied to the output connections of the generator.

This voltage is then applied to the second electric motor, which is connected to the transmission via a universal joint. The transmission, being supplied with mechanical energy from the electric motor, will supply this energy to the rear axle of the vehicle.

As to further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art.

All equivalent relationships to those illustrated in the sketch and described in the specification are to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A self-generating electric motor comprising a battery, starter, first universal joint, first electric motor, second universal joint, generator, third universal joint, transmission, fourth universal joint and rear end assembly. All components from the starter on to the rear axle assembly are connected via a common drive shaft and universal joints.

2. Self-generating electric motor according to claim # 1, wherein a battery is used to activate the starter to turn over the first electric motor.

3. Self-generating motor according to claim # 1 has a common drive shaft connected to the first electric motor, generator, the second electric motor, transmission and terminating at the rear axle assembly.

4. Self-generating electric motor according to claim # 2 uses the first electric motor to supply mechanical energy to the generator.

5. Self-generating electric motor according claim # 3 uses the generator to supply electrical energy to the second electric motor.

6. Self-generating electric motor according to claim # 3 uses the second electric motor to supply mechanical energy to the transmission.

7. Self-generating electric motor according to claim # 1 uses a universal joint to connect the starter to the first electric motor.

8. Self-generating electric motor according to claim # 1 uses a universal joint to connect the first electric motor to the generator.

9. Self-generating electric motor according to claim # 1. Uses a universal joint to connect the generator to the second electric motor.

10. Self-generating electric motor according to claim # 1 uses a universal joint to connect the second electric motor to the transmission.

11. Self-generating electric motor according to claim # 1 uses a universal joint to connect the transmission to the rear axle assembly.
